(19) United States
(12) Patent Application Publication
(10) Pub. No.: US 2006/0018255 A1
(43) Pub. Date: Jan. 26, 2006

(54) Defining a static path through a communications network to provide wiretap law compliance

(75) Inventor: Kaustubha A. Tankhiwale, Ocean, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 10/899,631

(22) Filed: Jul. 26, 2004

(51) Int. Cl. H04L 12/56

(52) U.S. Cl. 370/229

(57) ABSTRACT

By defining a static path through a communications network for a call placed by an IP-based telephonic device, stream of packets representing the call are rendered available for wiretapping on a communications network that includes a first and a second switching/routing element. The static path is defined using Multiprotocol Label Switching (MPLS) and Resource Reservation Protocol (RSVP). The first switching/routing element responds to a call initiation request received from the telephonic device by sending an RSVP PATH message to the second switching/routing element. The first switching/routing element marks packets sent by the telephonic device with an identical MPLS Forwarding Equivalence Class (FEC) label, so that the plurality of packets will traverse a predesignated IP address in the communications path, and so as to allow law enforcement officials to monitor packets originating from an IP-based telephonic device using a monitoring mechanism situated at the predesignated IP address.

### BACKGROUND OF THE INVENTION

1. Field of the Invention

The invention relates generally to communication networks and, more specifically, to techniques for routing a packet-based voice call over a known path on a communication network.

2. Description of the Related Art

By design, Internet Protocol (IP) allows data packets to travel from point A to point B over any available path. In a manner analogous to that of a motorist bypassing slow or stopped traffic, data packets are directed along a route so as to avoid congested network nodes. Although this traffic routing feature is desirable because it provides quick, efficient data packet transfers across the network, it poses a significant problem in situations where there is a need to monitor a stream of packets directed from point A to point B. Such a stream of packets may represent, for example, a telephone call using Voice over Internet Protocol (VoIP). Pursuant to the United States Federal Communications Assistance for Law Enforcement Act (CALEA), communication networks must be configured so as to provide authorities with the ability to wiretap telephone calls carried by the network, including calls that are carried using VoIP. Since IP allows individual packets to reach a destination across any of a variety of different pathways, capture of a specified packet stream corresponding to a given telephone call is virtually impossible.

One prior art technique for wiretapping a VoIP telephone call is presented in Cisco Internetwork Operating System (IOS) Software Release 12.1. Cisco IOS Software Release 12.1 provides the capability of tapping a VoIP call directed through a given switching/routing element based upon the Media Access Control (MAC) address of the call. The MAC address corresponds to a unique hardware number assigned to a specified computer equipped to communicate over the network. When a computer is connected to a network, a correspondence table relates the IP address of the computer to the computer's physical (MAC) address on the network. The MAC address is used by the Media Access Control sublayer of the Data-Link Layer (DLC) of a telecommunication protocol such as Vol P. Unfortunately, this technique for tapping VoIP calls is useful only in situations where one has knowledge of the specific switching/routing element or switching/routing elements used to carry the call. No mechanism is provided by which calls can be forwarded to a prespecified switching/routing element for wiretapping purposes.

### SUMMARY OF THE INVENTION

By defining a static path through a communications network for at least one call placed by an IP-based telephonic device, the novel methods of the present invention allow a stream of packets representing the call to be wiretapped on a communications network that includes at least a first and a second switching/routing element. This static path is defined using Multiprotocol Label Switching (MPLS) and Resource Reservation Protocol (RSVP) protocols. Pursuant to a first embodiment of the invention, the first switching/routing element responds to a call initiation request received from the IP-based telephonic device by sending an RSVP PATH message over the communications network to the second switching/routing element. The PATH message follows a route over the communications network as specified by existing MPLS settings. If the PATH message ascertains the availability of a communications path between the first and second switching/routing elements, the first switching/routing element marks a plurality of packets sent by the IP-based telephonic device with an identical MPLS Forwarding Equivalence Class (FEC) label, so as to cause the plurality of packets to traverse a predesignated IP address in the communications path. Implementing the MPLS and RSVP protocols in combination allows law enforcement officials and others to monitor packets originating from an IP-based telephonic device using a monitoring mechanism situated at the predesignated IP address.

Pursuant to a further embodiment of the invention, each switching/routing element in the communications path stores a previous source address specifying an address of a preceding switching/routing element from which the PATH message was received. After the second switching/routing element responds with the reservation request (RESV) message, the switching/routing elements send the RESV message from the second switching/routing element to the first switching/routing element using the stored previous source addresses so as to follow the communications path traversed by the PATH message in reverse.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a hardware block diagram of an illustrative operational environment in which the methods of the present invention are performed; and

FIGS. 2A and 2B together comprise a flowchart setting forth an operational sequence for establishing a static path through a packet-based communication network in accordance with a preferred embodiment of the invention.

### DETAILED DESCRIPTION OF THE PRESENTLY PREFERRED EMBODIMENTS

A major advantage of Voice over Internet Protocol (VoIP) is that it avoids the tolls charged by ordinary wired and wireless telephone service providers. Technical details of VoIP were developed by the VoIP Forum, an industry group comprised of participants from Cisco, VocalTel, 3Com, and Netspeak. The standard for VoIP is ITU-T H.323, which sets forth various protocols for sending voice, audio, and video across the public Internet or a private intranet using internet protocol (IP). Voice information is sent digitally in the form of discrete packets, as opposed to the traditional circuit-based protocols of the public switched telephone network (PSTN). Additionally, Session Internet Protocol (SIP) is an Internet Engineering Task Force (IETF) standard protocol for initiating an interactive user session that involves multimedia elements such as video, voice, chat, gaming, and virtual reality. SIP provides a mechanism for establishing, modifying, and terminating Internet telephony calls.

In a packet-switched system, data to be transmitted from one point to another is formed into short elements (known as packets) which are each handled separately, and routed according to the availability of network resources at the time of the transmission of the individual packet. This allows a large number of individual data messages to be sent simultaneously over any particular leg of the network, by interleaving packets of different calls over that leg. It is also possible to route different parts of the data (i.e. different packets) by different parts of the network, if there is insufficient capacity on any one route for the entire message. Each data packet carries an individual signaling overhead indicating the destination of the packet, so that at each node in the network the packet can be routed towards its ultimate destination. Each packet also carries a sequence number, to identify its position within the complete message, so that the receiving device can re-assemble the packets in the correct order at the receiving end, and can identify whether any packets have failed to arrive.

Although VoIP enables quick, efficient data packet transfers across communication networks, it poses significant problems in situations where there is a need to monitor communication content directed from point A to point B. One requirement of the United States Federal Communications Assistance for Law Enforcement Act (CALEA) is that communication networks must be configured so as to provide authorities with the ability to monitor (e.g., “wiretap”) telephone call data carried by the communication networks, including calls that are carried using VoIP. Since IP allows individual packets to reach a destination across any of a variety of different pathways, capture of a specified packet stream corresponding to a given telephone call is virtually impossible.

The novel techniques of the present invention enable a stream of packets representing a call to be wiretapped on a communication network. This functionality is provided by establishing a static path on the communication network for at least one received or placed call from a specified IP-based telephonic device. Pursuant to a preferred embodiment of the invention, the static path is defined using Multiprotocol Label Switching (MPLS) and Resource Reservation Protocol (RSVP).

MPLS is a standards-approved technology for facilitating the flow of packet traffic on communication networks. MPLS sets forth a mechanism for setting up a specific path for a given sequence of packets. The sequence of packets is identified by placing a label or identifier in each packet, thus saving the time that would otherwise be required for a switching/routing element to look up the address of a next switching/routing element or node to which the packet should be forwarded. MPLS is termed “multiprotocol” because it is equipped to operate in conjunction with Internet Protocol (IP), Asynchronous Transport Mode (ATM), and frame relay network protocols. With reference to the standard model for a network (the Open Systems Interconnection, or OSI model), MPLS allows most packets to be forwarded at the layer 2 (switching) level rather than at the layer 3 (routing) level. Forward Equivalence Class (FEC) sets forth the criteria used to determine if a plurality of packets are all to be forwarded in an equivalent fashion along the same label switch path.

RSVP sets forth communication rules that allow channels or paths on the Internet to be reserved for unicast (one source to one destination), multicast (one source to many receivers) and multi-source-to-single-destination transmissions of audio and video messages. In practice, RSVP may be employed to overcome an inherent limitation of the Internet. One basic routing philosophy on the Internet is “best effort,” which serves many users well but, nonetheless, is inadequate for reproducing continuous stream transmissions representing video, audio, or audiovisual programs. Internet users who wish to receive continuous stream transmissions can employ RSVP to reserve bandwidth through the Internet in advance of a desired transmission, thereby receiving the transmission at a higher data rate and in a less-interrupted data flow than would be the case if bandwidth had not been reserved. When an Internet program (i.e., transmission) commences, it will be unicast or multicast to those specific users who have reserved routing priority in advance.

Assume that a particular video program is to be multicast at a certain time on Sunday evening. Expecting to receive it, an Internet user sends an RSVP request to a web server before program transmission commences to allocate sufficient bandwidth and priority of packet scheduling for the program. This request is received by the Internet user's Point of Presence (POP) if the POP has an RSVP server. Otherwise, the request is handled by another POP, gateway or switching/routing element that includes an RSVP server. The RSVP server determines whether the Internet user is eligible to have such a reservation set up and, if so, whether sufficient bandwidth remains to be reserved without affecting earlier reservations. Assuming the reservation is requested and sufficient resources exist, the gateway then forwards the reservation to the next switching/routing element or gateway toward the destination (or source of the program transmission). In this manner, the reservation is secured all the way to the destination. On the other hand, if the reservation cannot be executed on all switching/routing elements between the Internet user and the destination, all switching/routing elements will remove the reservation. An RSVP packet is very flexible; it can vary in size and in the number of data types and objects. In the event data packets need to travel through gateways that do not support RSVP, they can be “tunneled” through as ordinary packets. RSVP works with Internet Protocol version 4 and Internet Protocol version 6.

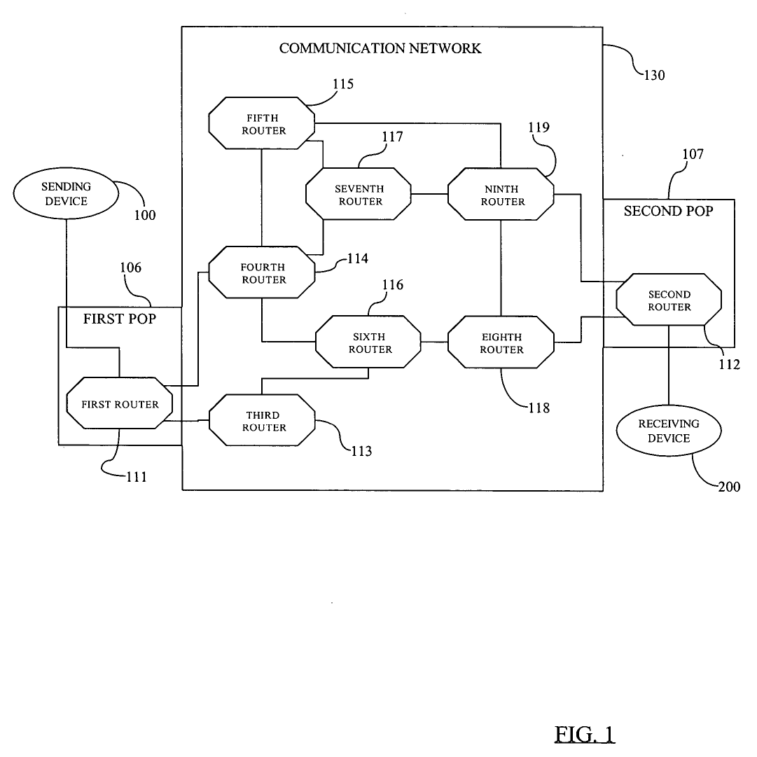

FIG. 1 is a hardware block diagram setting forth an illustrative operational environment in which the methods of the present invention are performed. A specified IP-based telephonic device is represented as sending device 100, or receiving device 200, or both. Sending device 100 and receiving device 200 each include a transducer mechanism for converting acoustical energy into electrical signals and for converting electrical signals into acoustical energy. Additionally, sending device 100 and receiving device 200 each include a computing mechanism and a data communications mechanism. The computing mechanism is equipped with VoIP software for converting electrical signals generated by the transducer mechanism into a plurality of data packets, and for converting a plurality of data packets into electrical signals which, when received by the transducer mechanism, cause acoustical energy to be generated. More specifically, the VoIP software causes electrical signals received from the transducer mechanism to be digitized, thereby generating a digitized data message. The VoIP software then divides the data message into a number of individual packets, and assigns an address header to each packet indicating the ultimate destination of the message. An address must be included within each packet because each packet is transmitted separately. The communications mechanism is equipped for transmitting and receiving these data packets on the Internet via an Internet Point of Presence (POP), such as POP 106 in the case of sending device 100 and POP 107 in the case of receiving device 200.

Voice over IP (VoIP) utilizes a protocol known as “User Datagram Protocol” (UDP). A UDP message includes an initial IP header, typically 20 bytes in length, that defines the destination, the source, and information such as the transmission protocol to be used. The initial IP header is followed by a UDP header of five bytes. The UDP header may be followed by other header information specifying the manner in which a payload is to be handled. The remainder of the packet comprises information to be conveyed, known as the “payload”. The other header information may be used to indicate the priority of a packet. For example, “Reservation Protocol” (RSVP) may be included, which reserves buffer space in an IP switching/routing element and prioritizes packets so that higher-priority packets are executed prior to lower-priority packets.

POP 106 and POP 107 each represent an access point for accessing a communication network 130 such as the public Internet or a private intranet. Each POP 106, 107 is assigned a unique Internet Protocol (IP) address. Internet service providers (ISPs) and online service providers (such as AOL) have a multiplicity of POPs on the Internet. In practice, a POP may reside in rented space owned by a telecommunications carrier (such as MCI or Sprint) to which the ISP is connected. A POP typically includes switching/routing elements, digital/analog call aggregators, servers, and possibly frame relays or ATM switches. In the example of FIG. 1, POP 106 is implemented using a first switching/routing element 111, and POP 107 is implemented using a second switching/routing element 112.

First switching/routing element 111 and second switching/routing element 112 are connected to communication network 130 which includes a third switching/routing element 113, a fourth switching/routing element 114, a fifth switching/routing element 115, a sixth switching/routing element 116, a seventh switching/routing element 117, an eighth switching/routing element 118, and a ninth switching/routing element 119. These switching/routing elements may each be implemented using at least one of a device and computer software equipped to determine the next place to which a packet should be forwarded toward its destination. In practice, a switching/routing element is often included as part of a network switch. Although nine switching/routing elements are used in the configuration of FIG. 1, this is only for illustrative purposes, as any number of switching/routing elements could be employed. First, second, third, fourth, fifth, sixth, seventh, eighth, and ninth switching/routing elements 111, 112, 113, 114, 115, 116, 117, 118, 119, respectively, are each connected to one or more other switching/routing elements over one or more communication links. Each switching/routing element decides where to send each packet based on that switching/routing element's current understanding of the current traffic flow and capacity of other switching/routing elements to which it is connected.

In accordance with a widely-utilized model of network programming known to skilled artisans as the Open Systems Interconnection (OSI) model, routing is a function associated with layer 3, also termed the network layer. The network layer is concerned with knowing the addresses of switching/routing elements in a communications network, selecting routes and quality of service, and recognizing and forwarding incoming messages for local host domains. Switching/routing element addresses may be specified in the form of layer 3 addresses, a suitable example of which is an Internet Protocol (IP) addresses. A switching/routing element creates and maintains a table of available routes to other switching/routing elements, as well as current conditions on these routes, using this information along with distance and cost algorithms to determine the best route for a given packet. The “best route” is, in most cases, considered to be the route that will offer the fastest transmission time across a communications network given current network usage. Typically, a packet may travel through a number of network points with switching/routing elements before arriving at its destination.

Pursuant to prior art approaches, upon receipt of a packet transmitted by sending device 100, first switching/routing element 111 selects the route most appropriate for the ultimate destination of the packet, given geographical, topological, and network capacity considerations. Assume that a set of packets from sending device 100 are destined for receiving device 200. Not all packets in the set are necessarily sent along the same route from switching/routing element to switching/routing element. For example, a first packet might be sent from first switching/routing element 111 to fourth switching/routing element 114, seventh switching/routing element 117, ninth switching/routing element 119, and second switching/routing element 112 before arriving at receiving device 200. A second packet might be sent from first switching/routing element 111 to fourth switching/routing element 114, fifth switching/routing element 115, seventh switching/routing element 117, ninth switching/routing element 119, and second switching/routing element 112 before arriving at receiving device 200. For each packet it receives, each switching/routing element decides where to send it next, according to the address header on the packet and information stored in a switching/routing element's routing table such as current capacity on communication links to other switching/routing elements. Since the route of a packet is not known in advance, prior art approaches do not provide any mechanism by which a stream of packets from sending device 100 to receiving device 200 may be monitored.

As will be explained in greater detail hereinafter, the methods of the present invention cause a plurality of packets sent by sending device 100 to be directed through third switching/routing element 113 at a third POP 140, so as to permit monitoring the contents of these packets at a monitoring device 300. The plurality of packets may take any predetermined path between first switching/routing element 111 and second switching/routing element 112, so long as this predetermined path includes third switching/routing element 113.

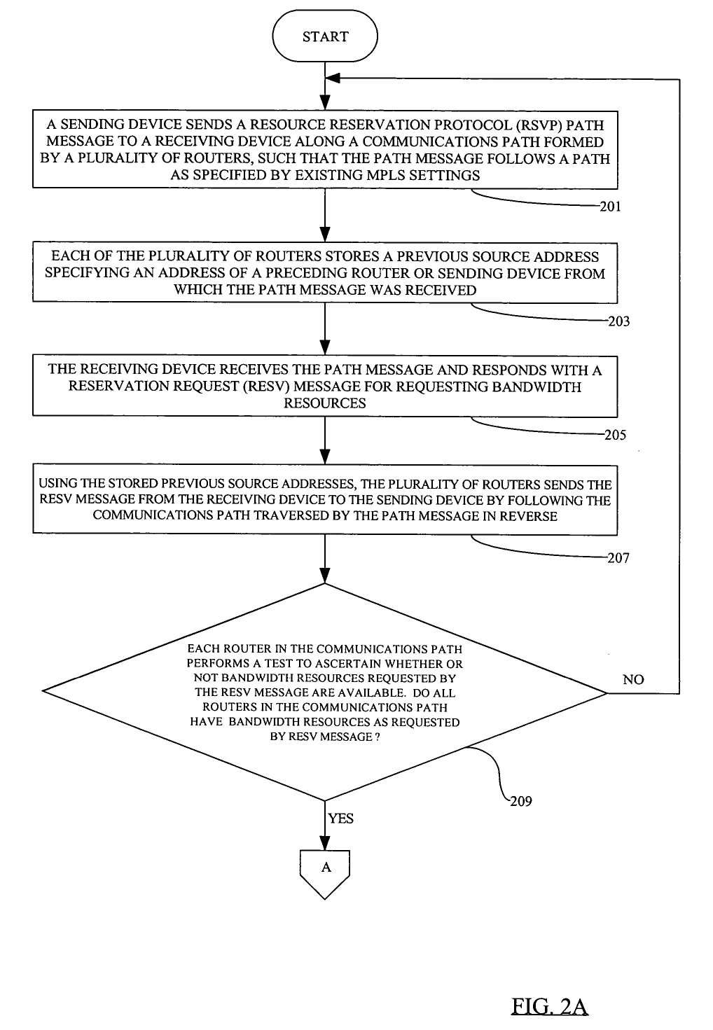

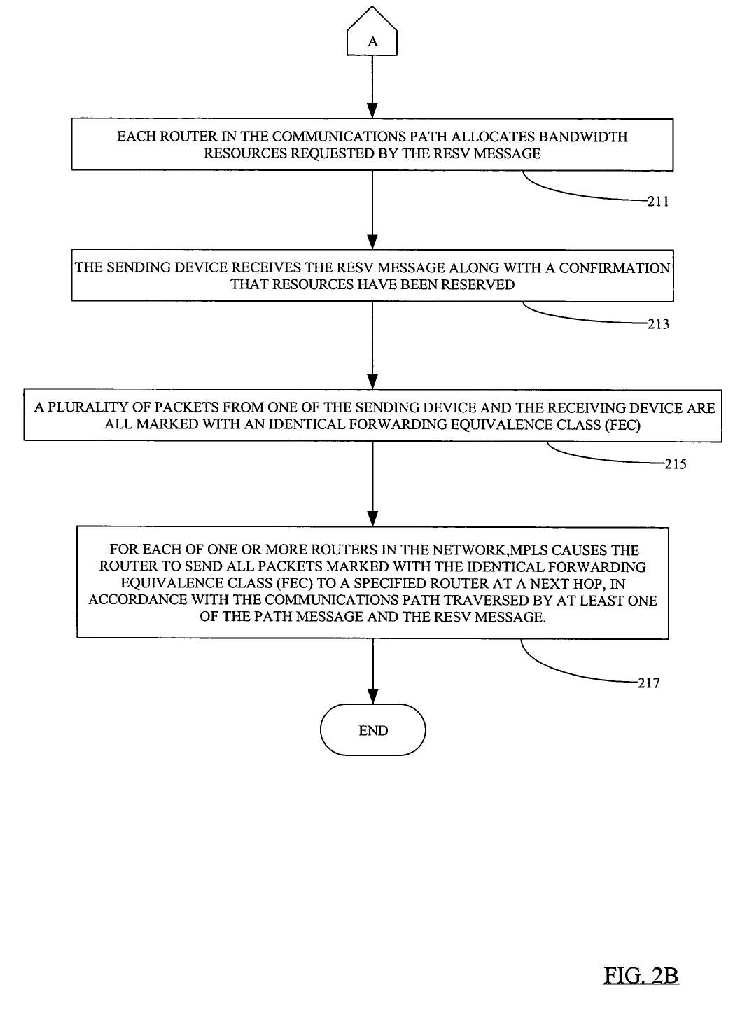

The manner in which packets are caused to traverse the predetermined path that includes third switching/routing element is described in connection with FIGS. 2A and 2B. Taken together, FIGS. 2A and 2B comprise a flowchart setting forth an operational sequence for establishing a static path through a packet-based communication network in accordance with a preferred embodiment of the invention, such that a stream of packets from sending device 100 to receiving device 200 may be monitored at monitoring device 300 (FIG. 1). In this manner, a stream of packets directed from sending device 100 to receiving device 200 are all sent along a predetermined route through communication network 130 that always includes third switching/routing element 113. The operational sequence of FIGS. 2A and 2B commences at block 201 (FIG. 2A) where, in response to a call initiation request received from sending device 100, first switch/routing element 111 (FIG. 1) sends a Resource Reservation Protocol (RSVP) path (PATH) message along a communications path formed by a plurality of switching/routing elements in communications network 130 between sending device 100 and receiving device 200. The PATH message follows a route through the communications network as specified by existing MPLS settings. In other words, MPLS determines the location to which the next message will be sent. At block 203 (FIG. 2A), each of the plurality of switching/routing elements stores a previous source address specifying an address of a preceding switching/routing element or sending device from which the PATH message was received. Second switching/routing element 112 (FIG. 1) receives the PATH message and responds with a reservation request (RESV) message for requesting bandwidth resources (FIG. 2A, block 205). Using the stored previous source addresses, the plurality of switching/routing elements sends the RESV message from the second switching/routing element to the first switching/routing element by following the communications path traversed by the path message in reverse (block 207). Each switching/routing element in the communications path performs a test to ascertain whether the bandwidth resources requested by the RESV message are available (block 209). If all switching/routing elements in the communications path have bandwidth resources as requested by the RESV message, the program progresses to block 211 (FIG. 2B) whereas, if one or more switching/routing elements in the communications path lack sufficient bandwidth to allocate resources as requested by the RESV message, the program loops back to block 201.

At block 211, each switching/routing element in the communications path allocates bandwidth resources requested by the RESV message. The first switching/routing element receives the RESV message along with a confirmation that resources have been reserved (block 213). The first switching/routing element marks a plurality of packets from the receiving device with an identical Forwarding Equivalence Class (FEC) (block 215). For each of one or more switching/routing elements in the network, Multiprotocol Label Switching (MPLS) causes the switching/routing element to send all packets marked with the identical Forwarding Equivalence Class (FEC) to a specified switching/routing element at a next hop along the communications path (block 217). In response to the identical FEC, at least one switching/routing element in the communications network is programmed to route all packets from the sending device through third switching element 113 (FIG. 1). In this manner, the MPLS and RSVP protocols ensure that an IP-based call using a specific telephonic device will traverse over a specific set of devices, thereby enabling law enforcement officials and others to monitor such calls.

Thus, while there have been shown and described fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for allowing a stream of data packets transmitted from an IP-based telephonic device along a communications network to be wiretapped, the communications network including at least a first and a second switching/routing element, the method comprising the steps of:
(a) the first switching/routing element responding to a call initiation request received from the IP-based telephonic device by sending a Resource Reservation Protocol (RSVP) PATH message over the communications network to the second switching/routing element; and
(b) if the PATH message ascertains availability of a communications path between the first and second switching/routing elements, the first switching/routing element marking a plurality of packets sent by the IP-based telephonic device with an identical Multiprotocol Label Switching (MPLS) Forwarding Equivalence Class (FEC) label, so as to cause the plurality of packets to traverse a predesignated IP address in the communications path.

2. The method of claim 1 further comprising the steps of each switching/routing element in the communications path storing a previous source address specifying an address of a preceding switching/routing element from which the PATH message was received;
such that, after the second switching/routing element responds with the reservation request (RESV) message, each switching/routing element in the communications path sends the RESV message from the second switching/routing element to the first switching/routing element using the stored previous source addresses, so as to follow the communications path traversed by the PATH message in reverse.

3. A method for programming a switching/routing element so as to allow a stream of packets received from an IP-based telephonic device to be wiretapped on a communications network, the method comprising the steps of:
(a) programming the switching/routing element to issue a Resource Reservation Protocol (RSVP) PATH message to reserve a predetermined communications path through the communications network in response to receiving a call initiation request from the IP-based telephonic device; and
(b) programming the switching/routing element to mark a plurality of packets with an identical Forwarding Equivalence Class (FEC) to cause the plurality of packets to traverse the predetermined communications path reserved in step (a).

4. A method for programming a first switching/routing element so as to allow a stream of packets sent by an IP-based telephonic device to be wiretapped on a communications network, the method comprising the steps of:
(a) in response to receiving a call initiation request from the IP-based telephonic device, the first switching/routing element sending a Resource Reservation Protocol (RSVP) path (PATH) message along a communications path formed by a plurality of switching/routing elements in the communications network between the IP-based telephonic device and a second switching/routing element;
(b) each of the plurality of switching/routing elements storing a previous source address specifying an address of a preceding switching/routing element from which the PATH message was received;
(c) the second switching/routing element receiving the PATH message and responding with a reservation request (RESV) message for requesting bandwidth resources;
(d) using the stored previous source address, each of the plurality of switching/routing elements sending the RESV message from the second switching/routing element to the first switching/routing element in reverse along the communications path traversed by PATH message;
(e) each switching/routing element allocating bandwidth resources requested by the RESV message if said bandwidth resources are available; and
(f) the first switching/routing element receiving the RESV message along with a confirmation that resources have been reserved.

5. The method of claim 4 further comprising the steps of:
(g) the first routing/switching element marking a plurality of packets from the IP-based telephonic device sending with an identical Forwarding Equivalence Class (FEC);
(h) using Multiprotocol Label Switching (MPLS) to cause each of the plurality of the switching/routing elements to send all packets marked with the identical Forwarding Equivalence Class (FEC) to a specified switching/routing element of the plurality of switching/routing elements at a next hop, in accordance with the communications path traversed by one of the PATH message and the RESV message, wherein an IP-based call using the IP-based telephonic device traverses over a predesignated switching/routing element in the communications network, such that the IP-based call may be wiretapped.
